(19) United States
(12) Patent Application Publication
(10) Pub. No.: US 2009/0035210 A1
(43) Pub. Date: Feb. 5, 2009

(54) CARBON BLACK

(76) Inventors: Kai Krauss, Hurth (DE); Alfons Karl, Grundau (DE); Burkhard Freund, Erftstadt (DE); Udo Wieschnowsky, Parkersburg, WV (US); Helmut Mangold, Rodenbach (DE); Kai Schumacher, Hofheim (DE); Rainer Golchert, Dieburg (DE); Helmut Roth, Mainaschaff (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/251,557

(22) Filed: Oct. 15, 2008

Related U.S. Application Data
(62) Division of application No. 10/976,357, filed on Oct. 28, 2004.
(60) Provisional application No. 60/519,740, filed on Nov. 13, 2003.

(30) Foreign Application Priority Data
Nov. 6, 2003 (DE) 103 51 737.5

(51) Int. Cl. C09C 1/48

(52) U.S. Cl. 423/449.1

(57) ABSTRACT

Carbon black with an OAN, measured on the beaded carbon black, of less than 120 ml/100 g. A process for the preparation of the carbon black is described, wherein a salt solution is converted into an aerosol and this is then introduced into the carbon black formation zone. The carbon black can be used in inks, paints, lacquers, printing inks and ink-jet inks, and for coloring plastics.

### REFERENCE TO RELATED APPLICATION

This application is a division of applicants' earlier filed copending application Ser. No. 10/976,357, filed Oct. 28, 2004 which in turn claims the benefit of German application No. 103 51 737.5 filed in Germany on Nov. 6, 2003 which are both relied on herein.

### INTRODUCTION AND BACKGROUND

The invention relates to a carbon black, a process for its preparation and its use.

DE 19650500 discloses doped, pyrogenically prepared oxides of metals and/or metal oxides which are doped with one or more doping components in an amount of 0.00001 to 20 wt.-%. The doped pyrogenically prepared oxides are prepared by adding an aerosol which comprises an aqueous solution of a metal and/or metal oxide to the gas mixture during flame hydrolysis of vaporizable compounds of metals and/or metal oxides.

A gas black process (DRP 29261, DE-PS 2931907, DE-PS 671739, Carbon Black, Prof. Donnet, 1993 by MARCEL DECCER, INC, New York, page 57 et seq.) in which a hydrogen-containing carrier gas loaded with oil vapours is burned in excess air at numerous discharge openings is furthermore known. The flames impinge on water-cooled rollers, which interrupt the combustion reaction. Some of the carbon black formed inside the flames is precipitated on the rollers and is scraped off from these. The carbon black remaining in the stream of waste gas is separated off in filters.

The channel black process (Carbon Black, Prof. Donnet, 1993 by MARCEL DECCER, INC, New York, page 57 et seq.) in which a large number of small flames fed by natural gas burn against water-cooled iron channels is furthermore known. The carbon black deposited on the iron channels is scraped off and collected in a funnel.

The carbon blacks prepared by these processes have numerous oxygen-functional groups on the surface and, due to the process, are highly structured, that is to say the carbon blacks consist of extended and branched aggregates.

A disadvantage of the known carbon blacks is that due to the process they have a very high structure and there is no possibility of reducing this directly during the preparation process.

### SUMMARY OF THE INVENTION

As described herein, there is provided a carbon black which has low structure, a lower viscosity and higher depth of color in the lacquer and renders possible a higher carbon black concentration in binder systems, at a constant viscosity, compared with carbon blacks wherein the structure has not been reduced.

The present invention also enables the structure of the carbon black to be determined in a targeted manner in the carbon black preparation process.

The present invention provides a carbon black, wherein the OAN, measured on the beaded carbon black, is less than 120 ml/100 g, preferably less than 110 ml/100 g, particularly preferably less than 100 ml/100 g.

The carbon black can have a COAN, measured on the beaded carbon black, of less than 90 ml/100 g, preferably less than 85 ml/100 g, particularly preferably less than 80 ml/100 g

The carbon black can have a difference, measured on the beaded carbon black, between the OAN and COAN of less than 30 ml/100 g, preferably less than 25 ml/100 g, particularly preferably less than 20 ml/100 g.

The carbon black can be a flame black, gas black or channel black.

The potassium content of the carbon black, measured on the carbon black powder, can be greater than 5 μg/g, preferably greater than 10 μg/g, particularly preferably greater than 50 μg/g. The potassium can be randomly distributed in the entire carbon black particle.

The BET surface area of the carbon black can be 50 m²/g to 500 m²/g, preferably 100 m²/g to 400 m²/g.

The carbon black according to the invention can be non-treated or after-treated, for example oxidized, functionalized or beaded.

The invention also provides a process for the preparation of the carbon black according to the invention, which comprises converting a salt solution into an aerosol with a gas, preferably air, nitrogen, hydrogen and/or hydrocarbon, and then introducing this into the carbon black formation zone.

The aerosol can be mixed into the carbon black raw material before the burner. In particular, in the gas black process the aerosol can be mixed into the carrier gas/oil vapour mixture before the burner.

The salt solution can be a solution of salt in water, alcohol or oil. The salt solution can comprise any salt which dissolves in water, alcohol or oil and can be converted into an aerosol. This can be, for example, an alkali metal or alkaline earth metal salt solution, preferably potassium salt solution, particularly preferably a potassium carbonate solution.

The aerosol can be prepared by a procedure in which a salt solution is atomized by atomizing air with an atomizing nozzle and the aerosol mist which forms is conveyed by air from the side out of the atomizing vessel into a heating zone.

The atomizing nozzle can comprise two nozzles directed against each other, through which the liquid is fed together with the atomizing air.

The salt solution in the atomizing vessel which has not been converted into the aerosol can pass downwards from the atomizing vessel into a reflux tank.

In the heating zone, the aerosol mist can be heated up to the extent that the salt solution no longer condenses. The temperature of the heating zone can be 50° C. to 400° C.

The device for the preparation of the aerosol can be made of glass, ceramic or high-grade steel.

The carbon blacks according to the invention can be used for the preparation of inks, paints, lacquers, printing inks and ink-jet inks, and for coloring plastics.

The carbon blacks according to the invention have the advantages that the structure is reduced and they have a low viscosity and relatively high depth of color in lacquer. They also render possible higher carbon black concentrations in binder systems, at the same viscosity, compared with carbon blacks of which the structure has not been reduced.

### BRIEF DESCRIPTION OF THE DRAWING

The present invention will be further understood with reference to the drawing which shows a schematic flow diagram of the process of the invention.

### DETAILED DESCRIPTION OF INVENTION

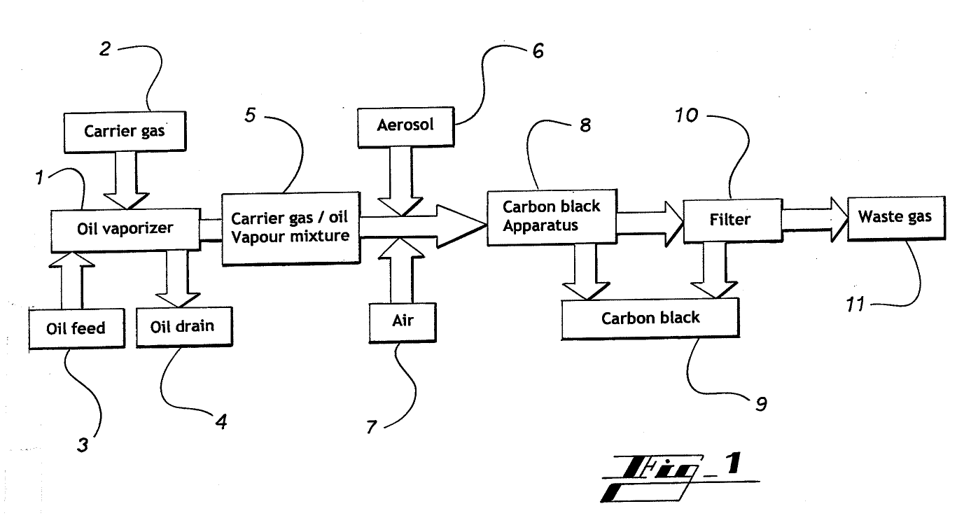

Referring To FIG. 1

An oil vaporizer (1) is used into which a carrier gas (2) and an oil feed (3) are introduced. An oil drain (4) is also provided. The carrier gas/oil vaporous mixture (5) is then conveyed with the aerosol (6) and air (7) to the carbon black apparatus (8). There, the reaction mixture is burned to produce the described carbon black which is removed (9) and the air and any residual carbon black is sent through a filter (10) to recover additional carbon black. Waste gas (11) is removed in a waste gas handler.

### EXAMPLE

FIG. 1 shows a diagram of the construction of the pilot plant used in this example.

Carbon black raw material I GN from Rütgers Chemicals AG is vaporized at the temperatures stated in table 1 in a commercially available thin film evaporator. The oil vapour is fed by the hydrogen gas stream stated in table 1 to a gas black apparatus. Directly before the burner (DE-PS 671739) the amounts of air and aerosol stated in the table are admixed to the gas and the mixture is fed to the flames. The aerosol is produced in an apparatus (DE 19650500) which comprises an atomizing region and a heating zone. In the atomizing region potassium carbonate solution with the concentrations stated in the table is fed to two nozzles which are directed against each other and produce a fine mist with the aid of the atomizing air. Condensed solution flows out of the apparatus. The mist is fed with the conveying air into the heating zone and is stabilized there at 180° C. The carbon black produced is separated out in commercially available filter units. The beaded carbon black is prepared from the carbon black powder in commercially available beading units.

The preparation conditions and results of examples 1-4 are shown in Table 1.

TABLE 1

| | Example | | | |
|---|---|---|---|---|
| | 1 | | | |
| | comparison | | | |
| | example | 2 | 3 | 4 |
| Potash concentration in g/l | — | 3.0 | 10.0 | 50.0 |
| Volume flow of hydrogen in m³/h | 4.0 | 4.0 | 4.0 | 4.0 |
| Amount of oil vapour in kg/h | 5.8 | 5.8 | 5.7 | 5.6 |
| Vaporization temperature in ° C. | 268.7 | 268.7 | 269.6 | 269.5 |
| Volume flow of air in m³/h | 19.0 | 17.0 | 17.0 | 17.0 |
| Air temperature in ° C. | 298 | 280 | 291 | 294 |
| Volume flow of air for the | 0.0 | 0.5 | 0.5 | 0.5 |
| atomization in m³/h | | | | |
| Volume flow of air for conveying the | 0.0 | 1.5 | 1.5 | 1.5 |
| aerosol in m³/h | | | | |
| Mass flow of additive solution in | 0.0 | 100.0 | 100.0 | 100.0 |
| g/h | | | | |
| Temperature of the heating zone of | — | 180.0 | 180.0 | 180.0 |
| the aerosol unit in ° C. | | | | |

Carbon black powder

| | | | | |
|---|---|---|---|---|
| Potassium content in μg/g | <1 | 37 | 102 | 390 |
| BET in m²/g | 148.5 | 155.3 | 152.7 | 154.5 |
| STSA in m²/g | 127.6 | 131 | 134.1 | 138.3 |
| Transmission in % | 91.9 | 94.6 | 93.6 | 92.7 |
| Oil requirement in g/100 g | 651 | 595 | 577 | 558 |
| OAN in ml/100 g | 146 | 132.0 | 101.1 | 101.1 |
| Viscosity at 80 s⁻¹ in mPas | 197 | 159 | 119 | 119 |
| Viscosity at 800 s⁻¹ in mPas | 107 | 85 | 70 | 65 |
| Jetness My | 268.2 | 270.5 | 273.4 | 275.8 |
| Hue dM | 8.8 | 9.2 | 10 | 10.3 |

Beaded carbon black

| | | | | |
|---|---|---|---|---|
| BET in m²/g | 147.6 | 151.8 | 150.1 | 152.5 |
| STSA in m²/g | 133.8 | 138.5 | 142.6 | 147.6 |
| OAN in ml/100 g | 128 | 119.7 | 92.3 | 90.7 |
| COAN in ml/100 g | 94.1 | 87.3 | 77.8 | 72.1 |
| Viscosity at 80 s⁻¹ in mPas | 79 | 60 | 51 | 40 |
| Viscosity at 800 s⁻¹ in mPas | 52 | 48 | 39 | 37 |
| Jetness My | 267.8 | 268.5 | 270.7 | 270.8 |
| Hue dM | 9.5 | 8.5 | 8.3 | 8.6 |

### Test Methods:

Potassium Content:

Exactly 2 g of sample are weighed into a clean platinum crucible. The sample is ashed at 600° C. in a muffle oven overnight. The residues are dissolved in 5 ml warm hydrochloric acid (30%, high purity) and the solution is topped up to 50 ml with highly pure water. The potassium content of the solution is determined by means of atomic absorption spectrometry (AAS).

| | |
|---|---|
| BET | ASTM D 4820 |
| STSA | ASTM D 5816 |
| Transmission | ASTM D 1618 |
| OAN | ASTM D 2414, |
| | but with a weight of 15 g carbon |
| | black and paraffin oil |
| COAN | ASTM D 3493, |
| | but with a weight of 15 g carbon |
| | black and paraffin oil |

### Oil Requirement:

The carbon black sample is dried for 1 hour at 115° C. The sample is then cooled for approx. 30 minutes in a desiccator. In the case of beaded carbon black, the carbon black must be comminuted with a steel spatula before addition of the oil, so that a paste just as homogeneous as that for the pulverulent carbon blacks is obtained.

The oil requirement is determined by dropwise addition of linseed oil varnish according to DIN 55 932 (Alberdingk, Krefeld) from a 2 ml burette to 0.5 g carbon black and grinding with an elastic steel spatula. The end point of the addition of oil is reached when a homogeneous standing paste has formed. A homogeneous standing paste exists when a conical peak is formed on drawing out the paste and this conical peak kinks when the glass plate is tapped gently, but does not yet collapse or run.

The evaluation is carried out in accordance with DIN EN ISO 787-5 (formula 2).

### Preparation of the Black Lacquer and Measurement of the Viscosity:

To prepare the millbase, 45.8 g water are initially introduced into the vessel and the following components are stirred in with a spatula in the sequence shown:

| | | |
|---|---|---|
| Tego ® Dispers 750 W, 40% | 23.4 | g |
| Tego ® Dispers 760 W, 35% | 6.6 | g |
| Tego ® Foamex | 0.3 | g |
| AMP 90 | 0.5 | g |
| Carbon black | 12 | g |

If appropriate, the pH is to be adjusted to 8.5 to 9 by addition of further AMP 90. Predispersing of the millbase is carried out with a laboratory dissolver (Pendraulik LR 34) at 4,000 rpm for 5 min with a disc diameter of 40 mm. After predispersing has been carried out, the pH is to be checked again and if appropriate adjusted to the set value with AMP. The dispersing is carried out in a Skandex Disperser (BA-S 20) with 540 g chromanite steel beads (diameter 3 mm) for a duration of 60 min at cooling level 2. The pH is to be checked again and if appropriate brought to the set value with AMP.

In accordance with DIN 54453 and DIN 53019, the viscosity is determined on the millbase at various shear gradients using a rotary viscometer (Visco-Tester 550, with PK 100 plate/cone 1°) from Haake.

To prepare the black lacquer, 5.4 g of the millbase and 24.6 g of a polyurethane dispersion (type U 710, manufacturer: Alberdingk Boley) are mixed in a 50 ml container of plastic by means of a dissolver at 2,000 rpm for 3 min with a disc diameter of 40 mm.

The finished lacquer is drawn on to a glass plate (90×130×1 mm) with the aid of a lacquer dumb-bell, gap height 150 μm. After evaporating in air for 30 minutes at room temperature, the lacquer layer is after-cured for 30 min at 80° C. in a drying cabinet.

The jetness My and hue dM are determined through the glass in accordance with DIN 55979 with a Q-Color 35 spectrophotometer from Pausch.

AMP is 2-amino-2-methyl-1-propanol (manufacturer: Angus Chemie).

NMP is N-methyl-2-pyrrolidinone.

Tego® Dispers 750 W, Tego® Dispers 760 W and Tego® Foamex are products from Tego Chemie, Essen.

Compared with example 1 (comparison example), examples 2-4 according to the invention have a low structure. The lacquers with examples 2-4 according to the invention have a lower viscosity and have a higher depth of color compared with comparison example 1.

The preparation conditions and results of examples 5-8 are shown in Table 2.

TABLE 2

| | Examples | | | |
|---|---|---|---|---|
| | 5 | | | |
| | comparison | | | |
| | example | 6 | 7 | 8 |
| Potash concentration in g/l | — | 3.0 | 10.0 | 50.0 |
| Volume flow of hydrogen in m³/h | 4.0 | 4.0 | 4.0 | 4.0 |
| Amount of oil vapour in kg/h | 3.0 | 3.0 | 2.6 | 3.0 |
| Vaporization temperature in ° C. | 242 | 242 | 242 | 242 |
| Volume flow of air in m³/h | 15.5 | 13.5 | 13.5 | 13.5 |
| Air temperature in ° C. | 290 | 296 | 298 | 292 |
| Volume flow of air for the | 0.0 | 0.5 | 0.5 | 0.5 |
| atomization in m³/h | | | | |
| Volume flow of air for conveying | 0.0 | 1.5 | 1.5 | 1.5 |
| the aerosol in m³/h | | | | |
| Mass flow of additive solution in | 0.0 | 100.0 | 100.0 | 100.0 |
| g/h | | | | |
| Temperature of the heating zone | — | 180.0 | 180.0 | 180.0 |
| of the aerosol unit in ° C. | | | | |

Carbon black powder

| | | | | |
|---|---|---|---|---|
| Potassium content/μg/g | 1.3 | 124 | 500 | 1700 |
| BET in m²/g | 269.45 | 268.6 | 310.6 | 324.2 |
| STSA in m²/g | 199.65 | 202 | 232.5 | 243.1 |
| Transmission in % | 97.8 | 96.9 | 96.4 | 95.6 |
| Oil requirement in g/100 g | 800 | 837 | 641.7 | 800 |
| OAN in ml/100 g | 173.6 | 134.4 | 130 | 121.2 |
| Viscosity at 80 s⁻¹ in mPas | 179 | 165 | 119 | 119 |
| Viscosity at 800 s⁻¹ in mPas | 98 | 76 | 72 | 59 |
| Jetness My | 295.6 | 304 | 313.7 | 317.4 |
| Hue dM | 8.7 | 10.3 | 10.2 | 10.7 |

Beaded carbon black

| | | | | |
|---|---|---|---|---|
| BET in m²/g | 244.9 | 286.9 | 308 | 307.3 |
| STSA in m²/g | 201.2 | 236.5 | 267.2 | 275.8 |
| OAN in ml/100 g | 140 | 112.9 | 93.4 | 82.9 |
| COAN in ml/100 g | 95.2 | 83.7 | 79.8 | 63.2 |
| Viscosity at 80 s⁻¹ in mPas | 60 | 40 | 20 | 20 |
| Viscosity at 800 s⁻¹ in mPas | 30 | 28 | 22 | 20 |
| Jetness My | 295.1 | 300 | 305.8 | 310.6 |
| Hue dM | 10.5 | 9.4 | 8.8 | 9.1 |

Compared with example 5 (comparison example), examples 6-8 according to the invention have a low structure. The lacquers with examples 6-8 according to the invention have a lower viscosity and have a higher jetness compared with comparison example 5.

Further variations and modifications of the foregoing will be apparent to those skilled in the art and are intended to be encompassed by the claims appended hereto.

1. A process for the preparation of gas black which comprises converting a salt solution into an aerosol with a gas and then introducing the aerosol into a carbon black formation zone, mixing said aerosol with a source of gas black raw material to form an admixture, subsequently heating said admixture to form said gas black.

2. The process according to claim 1, wherein the salt solution is an alkali metal or alkaline earth metal salt solution.

3. The process according to claim 1, wherein the salt solution is a potassium salt solution.

4. The process according to claim 1, wherein the salt solution is a potassium carbonate salt solution.

5. A process for the preparation of gas black as claimed in claim 1, which comprises converting a salt solution into an aerosol with a gas and then introducing the aerosol into a carbon black formation zone, mixing said aerosol with a source of gas black raw material to form an admixture, subsequently heating said admixture to form said gas black.

6. The process according to claim 5, wherein the salt solution is an alkali metal or alkaline earth metal salt solution.

7. The process according to claim 5, wherein the salt solution is a potassium salt solution.

8. The process according to claim 6, wherein the salt solution is a potassium carbonate salt solution.

9. A gas black, wherein the OAN, measured on the beaded carbon black is less than 110 ml/100 g. prepared by a process comprising:
converting a salt solution into an aerosol with a gas and then introducing the aerosol into a carbon black formation zone, mixing said aerosol with a source of gas black raw material to form an admixture, subsequently heating said admixture to form said gas black or channel black.
